(19) United States
(12) Patent Application Publication
(10) Pub. No.: US 2001/0046258 A1
(43) Pub. Date: Nov. 29, 2001

(54) Portable, self-contained satellite transceiver

(75) Inventors: Andrew Charles Furlong Wise, Fulham (GB); Philip Macridis, London (GB)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Ipaxis Holdings, Ltd., Hamilton (BM)

(21) Appl. No.: 09/859,241

(22) Filed: May 17, 2001

Related U.S. Application Data
(60) Provisional application No. 60/205,035, filed on May 18, 2000.

(51) Int. Cl. H04B 1/38

(52) U.S. Cl. 375/219

(57) ABSTRACT

A portable, self-contained satellite transceiver is employed for establishing a communications link between a connected appliance and a satellite, the satellite including polarized transmit and receive antennas. The transceiver comprises a base unit, including a generally planer upper surface and a direction indicator to facilitate orientation of the base unit along a selected azimuth for communication with the satellite. A generally plate-like antenna support member is pivotally connected to one end of the base unit housing so that the antenna support member is pivotable between a first or transport position and a second position at a selected angle to establish elevational alignment with the satellite. An antenna housing contains polarized, transmit and receive antennas suitable for communicating with the satellite. The antenna housing is rotatable with respect to the antenna support member to a selected angle for aligning the polarization of the antennas with the polarization of the satellite antennas.

### CROSS-REFERENCE TO RELATED APPLICATIONS

The present application claims the benefit of U.S. Provisional Patent Application No. 60/205,035, filed May 18, 2000 and entitled “Small Sized Portable Satellite Transceiver”, the subject matter of which is hereby incorporated herein by reference.

### BACKGROUND OF THE INVENTION

The present invention relates generally to a portable, self-contained satellite transceiver, and, more particularly, to a small sized portable satellite transceiver which is readily adapted for use with a portable appliance such as a laptop computer, palmtop computer or the like to provide a communications link with a satellite.

As computing and communication systems further develop there is a need to provide constant communications between a portable appliance or computer device, such as a laptop computer, palmtop computer and the like and a remote base station, network or the like. While, in some instances, effective communications can be provided by an existing cellular telephone network, such networks have been found to have disadvantages when used in connection with portable computers. In addition, access to acceptable cellular telephone networks is not available in many regions of the world.

Therefore, there exists a need for a small sized, self-contained portable satellite transceiver which can be quickly and easily setup anywhere in the world to provide instantaneous communication between a portable appliance or device, such as a laptop computer, palmtop computer or the like and a base station or network located anywhere in the world.

### BRIEF SUMMARY OF THE INVENTION

Briefly stated, the present invention comprises a portable, self-contained satellite transceiver for establishing a communications link between a connected appliance and a satellite which includes polarized transmit and receive antennas. In a preferred embodiment, the transceiver comprises a base unit, including a housing containing electronic components of the transceiver. The housing includes a generally planar upper surface, a lower surface generally parallel with the upper surface and a direction indicator to facilitate orientation of the base unit along a selected azimuth for communication with the satellite. A generally plate-like antenna support member is provided with one end being pivotally connected to one end of the base unit housing. The antenna support member includes a generally planar lower surface and a generally planar upper surface, generally parallel with the lower surface. The antenna support member is pivotable between a first position in which the lower surface of the antenna support member is facing and generally parallel with the upper surface of the base unit housing and a second position in which the lower surface of the antenna support member forms a selectable angle with respect to the upper surface of the base unit housing to establish elevational alignment with the satellite. An antenna housing containing polarized transmit and receive antennas suitable for use in communicating with the satellite is included. The antenna housing has a generally planar lower surface which is generally parallel with the upper surface of the antenna support member. The antenna support member rotatably supports the antenna housing so that the antenna housing is rotatable to a selected angle for aligning the polarization of the antennas within the antenna housing with the polarization of the satellite antennas.

In a first preferred embodiment, the alignment of the transceiver with respect to the satellite is accomplished manually and in a second preferred embodiment, the alignment is accomplished in an automated manner.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a perspective view of a first preferred embodiment of a satellite transceiver in accordance with the present invention with the antenna support member and an antenna housing elevated;

FIG. 2 is a left side elevational view of the transceiver of FIG. 1 with the antenna support member and an antenna in a non-elevated or transport position;

FIG. 2A is an enlarged fragmentary view of a portion of the transceiver of FIG. 2.

FIG. 3 is a left side elevational view of the transceiver of FIG. 1;

FIG. 4 is a view similar to FIG. 3 illustrating an alternate embodiment of the transceiver of FIG. 1;

FIG. 5 is a top plan view of the base unit housing obtained by viewing the transceiver of FIG. 3, taken along lines 5-5;

FIG. 6 is a cross-sectional view taking along lines 6-6 of FIG. 3 to illustrate the structure of the antennas within the antenna housing;

FIG. 7 is a top plan view of the transceiver of FIG. 1 with the antenna housing rotated to a selected angle;

FIG. 8 is a front elevational view, partially broken away, of the transceiver of FIG. 1 and with the antenna housing rotated to a selected angle;

FIG. 9 is a cross-sectional view of the transceiver taking along lines 9-9 of FIG. 8;

FIG. 10 is a left side elevational view, partially broken away, of a satellite transceiver in accordance with a second preferred embodiment of the present invention;

FIG. 11 is a cross-sectional view of a portion of the transceiver taking along lines 11-11 of FIG. 10;

FIG. 12 is a bottom plan view of the transceiver of FIG. 10;

FIG. 13 is a front elevational view, partially broken away, of the transceiver of FIG. 10; and

FIG. 14 is a schematic block diagram illustrating some of the functional aspects of a transceiver in accordance with the present invention.

### DETAILED DESCRIPTION OF THE INVENTION

Referring to the drawings, wherein like numerals are used to indicate like components throughout the several figures, there is shown in FIGS. 1-9, a first preferred embodiment of a portable, self-contained satellite transceiver 10 in accordance with the present invention. The satellite transceiver 10, as shown, is comprised of three principle assemblies: a base unit 12, an antenna support member 14 and an antenna housing 16. The three principal assemblies are interconnected and function together to permit the establishment of a communications link between a connected appliance (not shown) and a base station, network or the like (not shown) through a satellite (not shown). The connected appliance could include, but is not limited to a computer, such as a personal computer, laptop computer, palmtop computer or the like, a personal digital assistance device or any other electrical or electronic device suitable for interconnecting, through a communication, link with a distance base station, network or the like. The satellite is preferably a standard communications satellite of the type used for providing communication links between two earth bound locations. The base station or network may be any existing system, sub-system or the like which may be interconnected to an appliance of the type described. While for purposes of illustrating the operation of the present invention certain appliances and certain base station or networks have been described. It should be appreciated by those of ordinary skill in the art that the present invention may be used for establishing communication between any electrical or electronic device, system or subsystem and any other electrical or electronic device, system or sub-system by way of a satellite link.

The base unit 12 includes a box-like housing 18 which preferably contains all of the electrical and electronic and other components (other than the antenna) necessary for complete operation of the transceiver 10. In the present embodiment, the transceiver 10 is designed to function within the Ku band. Base band electronics and other electronic and non-electronic components necessary for the transceiver 10 to provide communications in the Ku band are well known to those of ordinary skill in the art and need not be described in detail for a complete understanding of the structure and operation of the present invention. If desired, all or some of the electronic and/or other transceiver components could be located within or could be secured to the antenna support member 14 and/or the antenna housing 16. Alternatively, all or some such components could be incorporated into a separate, connected housing (not shown).

The base unit housing 18, in the present embodiment, is formed of a molded polymeric material and preferably is approximately 30 cm×30 cm with a depth or height of approximately 2 cm. It should be understood by those of skill in the art that the base unit housing 18 could be formed of some other material, or combination of materials such as, an aluminum alloy, a steel alloy or the like. It should also be appreciated by those of ordinary skill in the art that the base unit housing 18 need not be of the specified dimensions and, in fact, need not be square or have any particular shape. However, in order to maintain the portability of the transceiver 10, it is preferable that the base unit housing 18 be relatively small, compact and relatively light in weight.

In the present embodiment, power for the transceiver 10 is provided by a battery (not shown) which is preferably located within the base unit housing 18. The battery, which may be either of the rechargeable or non-rechargeable type, is preferably heavy enough to weight down and therefore, provide additional stability to the base unit housing 18, but is not so heavy as to preclude the transceiver 10 from being light weight and portable. If desired, a plurality of batteries may alternatively be employed to provide power to the transceiver. As a further alternative, power for the transceiver may be obtained from a separate power source, such as a wall outlet, separate battery housing, generator, or the like. Further details concerning the power source for the transceiver 10 are not believed to be necessary for a complete understanding of the present invention.

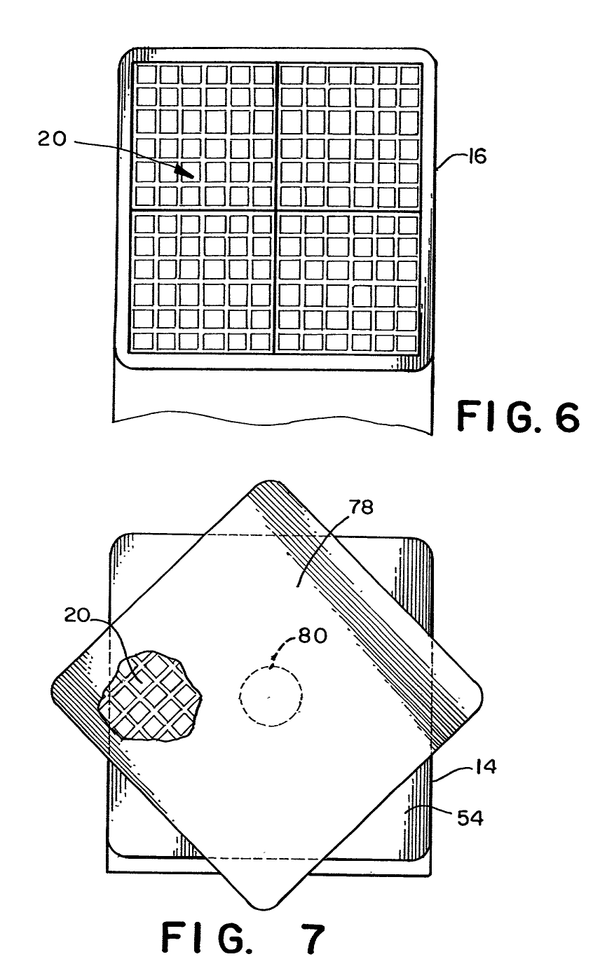

As best shown in FIG. 6, the antenna housing 16 includes polarized transmit and receive antennas 20 which, in the present embodiment, comprise 144 elements orthagonally arranged in four generally equally sized square quadrants. Thus, with the present embodiment, the polarization of the antennas 20 may be varied by varying the orientation of the antenna housing 16. In this manner, the polarization of the antennas 20 within the antenna housing 16 may be adjusted to match the polarization of the antennas of a satellite. It will be appreciated by those of ordinary skill in the art that the number of antennas, the arrangement of the antennas and other aspects of the antennas 20 of the transceiver 10 may vary from what is described above and shown in the drawings. Accordingly, the present invention is not limited to a particular number or arrangements of antennas.

In order to permit the transceiver 10 to function in the Ku band to effectively provide communications with a particular satellite, the antennas 20 must be consistently and carefully aligned with regard to the satellite in three aspects, including alignment along a correct direction or azimuth with respect to the satellite, correct elevational alignment with respect to the satellite and correct polarization of the transmit and receiver antennas with respect to the polarization of the satellite receive and transmit antennas. The structure of the transceiver 10 as hereinafter described facilitates quick, consistent alignment of the transceiver 10 for optimal communication with a selected satellite.

The base unit housing 18 in the present embodiment, is generally box-like and includes a generally planar upper surface 22, a generally planar lower surface 24, which is generally parallel to the upper surface 22 and four interconnecting side surfaces, including front and rear surfaces 26, 28 and left and right side surfaces 30, 32. While the base unit 18 in the present embodiment is box-like and is generally square in plan view, it will be appreciated by those of ordinary skill in the art that the base unit housing 18 could have some other shape (such as rectangular, octagonal or the like), if desired. The base unit housing 18 includes a level measuring device for indicating whether the base unit housing 18 is in a level condition. In the present embodiment, the level measuring device comprises a bubble spirit level 34 located on the upper surface 22 of the base unit housing 18. It will be appreciated by those of ordinary skill in the art that any other suitable level measuring device may alternatively be employed and that the level measuring device may be at any other suitable location, if desired.

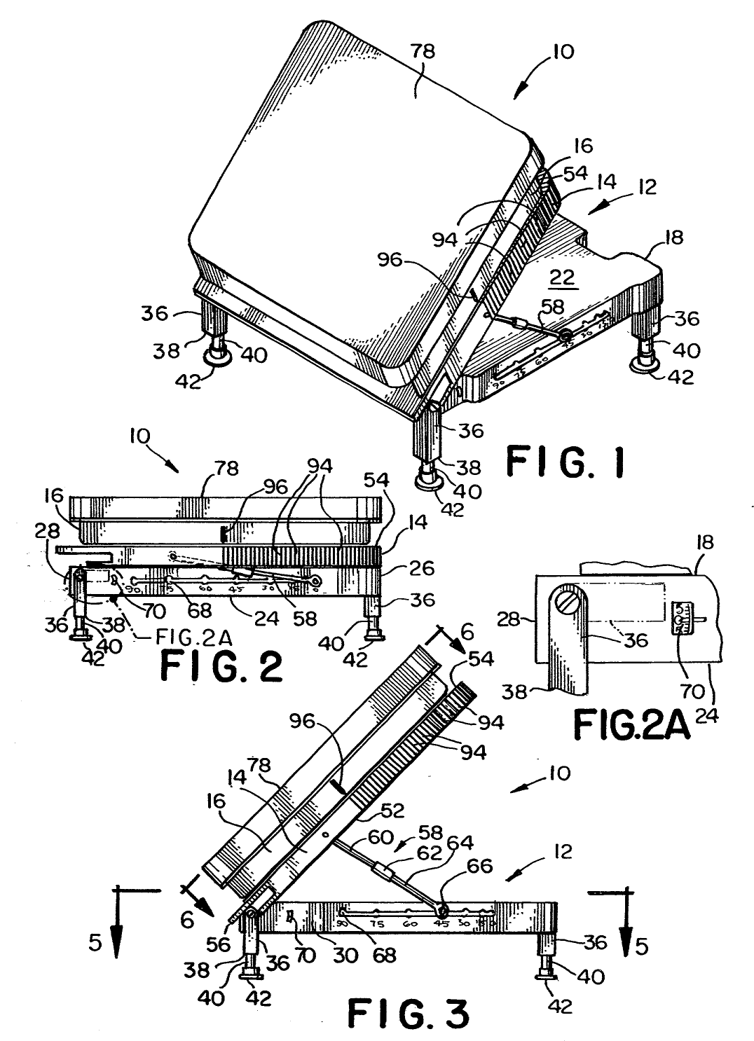

The base unit housing 18, in the present embodiment, includes a plurality of adjustable feet 36 extending downwardly from the lower surface 24. Preferably, four such adjustable feet 36 are included with one adjustable foot being located proximate to each of the corners of the base unit housing 18. As shown in FIG. 2A, each of the adjustable feet 36 are pivotally secured to the base unit housing 18 so that the adjustable feet 36 are retractable from the extended position as shown in FIG. 1, to a retracted or stowed position as shown in phantom in FIG. 2A during transport of the transceiver 10. Each of the adjustable feet 36 include a pivotable support member 38 having a threaded opening (not shown) for receiving one end of a threaded adjustment member 40. The other end of the adjustment member 40 includes a generally circular, generally flat engagement member 42 for engaging a supporting surface. In this manner, using the spirit level 34 as a guide, the adjustment members 40 of each of the adjustable feet 36 may be rotated with respect to the applicable support members 38 for raising or lowering the engagement members 42 for steadying and leveling the base unit housing 18 on the supporting surface. It will be appreciated by those of ordinary skill in the art that other suitable techniques known to those of ordinary skill in the art, may alternatively be employed for leveling the base unit housing 18. It will also be appreciated by those of ordinary skill in the art that the adjustable feet 36 need not be retractable. Finally, it will be appreciated by those of ordinary skill in the art that in some embodiments, it will not be necessary or desirable to utilize the adjustable feet 36 for leveling the base unit housing 18.

The base unit housing 18 also includes a direction indicator to facilitate orientation of the base unit 12 in a particular direction, along a selected azimuth for communication with the satellite. In presently preferred embodiment, the direction indicator comprises a compass 44, which preferably is a fluxgate digital compass. As shown in FIG. 5, the compass 44 is preferably located on the upper surface 22 of the base unit housing 18. However, the compass 44 could be positioned at some other suitable location. In addition, a different type of compass 44, such as a mechanical compass could be employed or, in the alternative, a different direction indicator could be employed. The only requirement is that the direction indicator be sufficient to permit a user to orient the base unit 12 in a direction or along an azimuth for proper alignment to facilitate communication with the selected satellite.

The base unit housing 18 further includes at least one connector (not shown) to permit forming an electrical connection between the transceiver 10 and an appliance or other device. Preferably the connector is a USB connector, but any other suitable connector, such as, but not limited to a Blue Tooth, an RS 232, an RS 422 or an Ethernet connector could alternatively or additionally be employed.

In the presently preferred embodiment, the transceiver 10 includes a signal strength detector (not shown) which includes an indicator (not shown) for indicating the strength of signals received from the satellite. The signal strength detector is of a type well known to those of ordinary skill in the art and the signal strength indicator may be either a visual or audible indicator also of a type well known to those of ordinary skill in the art. The signal strength detector and indicator may be employed for adjusting the position of the antennas 20 to obtain optimal signal strength to thereby, facilitate optimal communication with the satellite.

The antenna support member 14 is generally plate-like and includes a generally planar lower surface 52 and a generally planar upper surface 54 which is generally parallel with the lower surface 52. Preferably, the antenna support member 14 is generally square in plan view and has approximately the same dimensions as or is slightly smaller than the base unit housing 18 as best shown in FIG. 2. As illustrated in FIGS. 1 and 3, one end 56 of the antenna support member 14 is pivotally connected to one end of the base unit housing 18 proximate to the rear surface 28. Preferably, the connection is a hinge connection which employs at least one pin to facilitate the pivoting of the antenna support member 14 with respect to the base unit housing 18 as illustrated by referring to FIGS. 1-3. Thus, the antenna support member 14 is pivotable between a first or transport position as shown in FIG. 2 and a selectable second or operational position as illustrated by FIG. 3. In the first or transport position (FIG. 2), the lower surface 52 of the antenna support member 14 is facing and generally parallel with, and preferably engaging, the upper surface 22 of the base unit housing 18. In the second or operational position (FIG. 3), the lower surface 52 of the antenna support member 14 forms a selectable angle with respect to the upper surface 22 of the base unit housing 18. The selected angle may be anywhere between zero and ninety degrees, depending upon the degree of elevation required for alignment of the antennas 20 with the satellite. It will be appreciated by those of ordinary skill in the art that while a hinge connection is presently preferred, the antenna support member 14 may be pivotally secured to the base unit housing 18 using any other connecting device or technique suitable for permitting the antenna support member 14 to be pivoted to the selected angle for proper elevational alignment of the antennas 20 with the satellite.

In the present embodiment, a support assembly 58 is provided for maintaining the antenna support member 14 at the selected angle with respect to the base unit housing 18 and to facilitate fine adjustment of the selected angle. As best shown in FIG. 3, the support assembly 58 includes a first support arm or support rod 60, which is pivotally secured on one end at a fixed location on the antenna support member 14. The other end of the first support rod 60 is threadingly connected to one end of a threaded adjustment member 62. The other end of the threaded adjustment member 62 is threadingly connected to one end of a second support arm or a second support rod 64. The other end of the second support rod 64, includes an extension pin 66 which may be placed in a selected one of a plurality of spaced apart, generally circular locating sockets or openings 68 on the left side surface 30 of the base unit housing 18. As shown in FIG. 3, the support assembly 58 forms a generally straight, rigid structure so that when the extension pin 66 is placed in one of the openings 68, the support assembly 58 maintains the antenna support member 14 roughly at a selected angle with respect to the base unit housing 18. The rough selected angle is established by the particular opening 68 within which the extension pin 66 is placed. Thus, for example, placing the extension pin 66 in an opening close to the front surface 26 of the base unit housing 18 maintains the antenna support member 14 at a relatively small angle and placing the extension pin 66 in an opening 68 closer to the rear surface 28 of the base unit housing 18 maintains the antenna support member 14 at a much greater angle. Preferably, indicia are provided on the left surface 30 of the base unit housing 18 proximate to each of the openings 68 to assist a user in selecting the appropriate opening 68 for a desired rough angle. Fine tuning or adjustment of the angle may be accomplished by rotating the adjustment member 62 to either lengthen or shorten the support assembly 58 by a limited degree. Preferably, an indicator 70 (FIG. 2A) is provided on the base unit housing 18 for displaying the actual elevation angle of the antenna support member 14 with respect to the base member housing 18. A second support assembly 58 may be employed on the right side of the base unit housing 18 for more precise control of the selected angle. Preferably, each support assembly 58 is made of a polymeric material, but other generally rigid materials could be used. It should be appreciated by those of ordinary skill in the art that while the present embodiment employs a support assembly 58 for maintaining and adjusting the angle of the antenna support member 14 with respect to the base unit housing 18, other structures or techniques may be alternatively employed for this purpose. For example, the connection between the antenna support member 14 and the base unit housing 18 could include a friction joint formed of a self-lubricating material, such as nylon, teflon or the like to permit smooth movement between the antenna support member 14 and the base unit housing 18 while allowing the connection to be sufficiently tight to hold the antenna support member 18 at a selected angle. Some other type of joint, such as a ratchet mechanism (not shown) may alternatively be employed for connecting the antenna support member 14 to the base unit housing 18. As a further alternative, a separate locking mechanism which may include, for example, a wing nut (not shown), may be used to hold the antenna support member 14 in place once the selected angle is established.

In the present embodiment, the antenna support member 14 is preferably formed of a high strength polymeric material. However, it will be appreciated by those of ordinary skill in the art that any other suitable material, such as an aluminum alloy, a steel alloy or the like may alternatively be used for the antenna support member 14.

The antenna housing 16 in the present embodiment is generally box-like and square having dimensions which are substantially the same as or slightly smaller than the dimensions of the base unit housing 18. The antenna housing 16 has a generally planar lower surface 76 which is generally parallel with the upper surface 54 of the antenna support member 14. As best shown in FIGS. 7, 8 and 9, the antenna support member 14 rotatably supports the antenna housing 16 with a rotating joint so that the antenna housing 16 is rotatable to a selected angle for aligning the polarization of the antennas 20 with the polarization of the satellite antennas. A cover member 78 extends over the upper portion of the antenna housing 16 for covering the antennas 20.

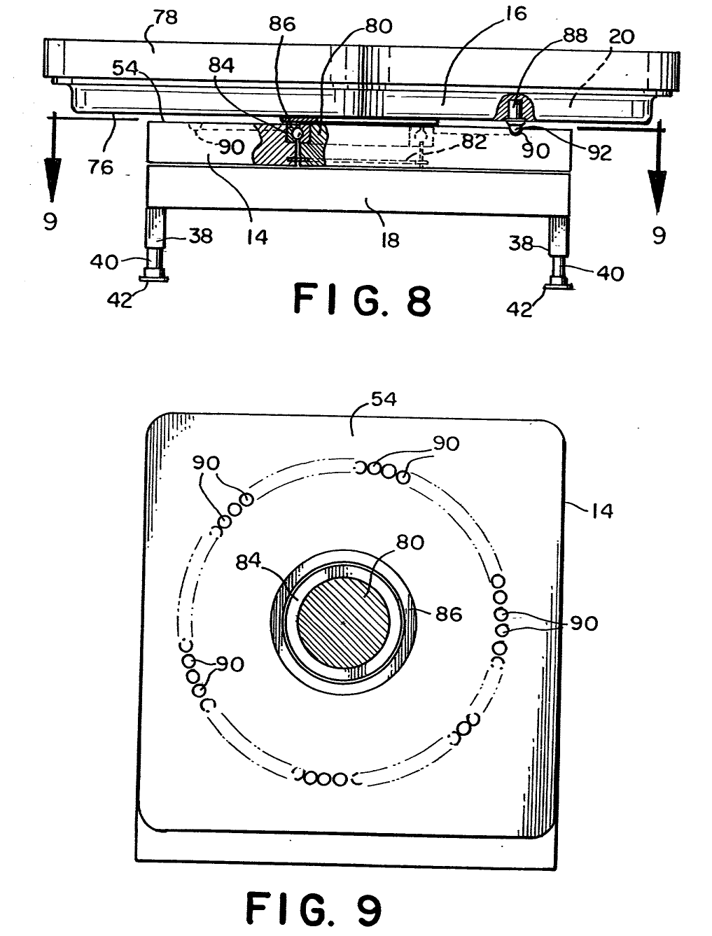

The rotating joint between the antenna support member 14 and the antenna housing 16 is established by a downwardly extending generally cylindrical boss 80 on the lower surface 76 of the antenna housing 16 proximate to the center thereof. The boss 80 is journaled for rotation within a similarly sized opening 82 in the upper surface 54 of the antenna support member 14 by a ball bearing assembly 84 as best shown in FIG. 8. At least, one generally angular slip ring 86 preferably formed of nylon, teflon or a similar self-lubricating material is positioned between the lower surface 76 of the antenna housing 16 and the upper surface 54 of the antenna support member 14 to restrict vertical movement therebetween while facilitating rotation of the antenna housing 16. It will be appreciated by those of ordinary skill in the art that other structures or techniques may be employed for creating the rotating joint between the antenna housing 16 and the antenna support member 14. The only requirement of the rotating joint is that the antenna housing 16 have the ability to freely rotate with respect to the antenna support member 14 in a smooth, stable manner.

The rotational position of the antenna housing 16 is controlled by a spring loaded detent device 88 extending downwardly from the lower surface 76 of the antenna housing 16 in cooperation with a series of semispherical detent dimples 90 arranged in a generally circular pattern on the upper surface 54 of the antenna support member 14. The detent device 88 has a structure well known to those of ordinary skill in the art and includes a generally spherical ball member 92 which is biased by a spring (not shown) to extend into one of the dimples 90 when the detent device 88 is aligned with a dimple 90 to thereby, effectively retain the antenna housing 16 in place with respect to the antenna support member 14. Rotation of the antenna housing 16 with sufficient force causes the ball member 92 to overcome the bias of the spring and thereby, move out of the dimple 90 until the rotating force is removed whereupon the ball member 92 moves into a corresponding dimple 90 to thereby retain the antenna housing 16 at the selected rotational location. Preferably, the dimples 90 are spaced apart a predetermined distance so that the movement of the ball member 92 from any one dimple 90 to the next dimple 90 results in approximately one degree of rotation of the antenna housing 16. It will be appreciated by those of ordinary skill in the art that some other suitable device or technique could be employed for retaining the antenna housing 16 at a desired rotational location with respect to the antenna support member 14, if desired. Accordingly, the present invention is not limited to the detent device 88 as described above.

As best shown in FIGS. 1-3, an indicator is provided for displaying the angle of rotation of the antenna housing 16 with respect to the antenna support member 14 and for thereby indicating a polarization angle of the antennas 20. In the present embodiment, the indicator comprises a plurality of notches or lines 94 along a portion of the antenna support member 14 and a single notch or line 96 on the side of the antenna housing 16. It will be appreciated by those of ordinary skilled in the art that other types of indicators or indicator techniques could alternatively be employed.

In the present embodiment, the antenna housing 18 is preferably formed of a metalized polymeric material. It will be appreciated by those of ordinary skill in the art that other materials, such as an aluminum alloy or a steel alloy could alternatively be employed. Preferably, the cover 78 is also formed of a polymeric for other suitable material.

To make use of the transceiver 10, a user must have certain information concerning the satellite with which the communication is to be established. Thus, it is necessary for the user to know the location of the satellite to establish the proper azimuth, the angle of the satellite with respect to the horizon to establish the proper elevation of the antennas 20 and the polarization of the transmit and receive antennas of the satellite. The adjustable feet 36 are pivoted to their extended positions as shown in FIGS. 1-3 and the transceiver is positioned on a suitable supporting surface in general alignment with the direction of the selected satellite with the adjustable feet 36 engaging the supporting surface. Preferably, the adjustment members 40 of one or more of the adjustable feet 36 are rotated while observing the spirit level 34 to adjust the position of the base unit housing 18 relative to the supporting surface until the transceiver 10 is level and steady. Using the fluxgate digital compass 44, the orientation of the transceiver 10 is adjusted until the transceiver 10 is oriented along the correct azimuth for proper alignment with the selected satellite.

Next, the antenna support member 14 is pivoted with respect to the base unit housing 18 until it is approximately equal to the angle necessary for elevational alignment with the satellite. The extension pin 66 is then inserted into the appropriate opening 68 for the selected angle. Thereafter, the adjustment member 62 is rotated while observing the indicator 70 for fine adjustment of the elevational angle.

Once the correct elevational angle of the antenna support member 14 is established, the antenna housing 16 is rotated with respect to the antenna support member 14 until the antennas 20 attain a polarization which corresponds to the polarization of the antennas of the satellite. The indicator lines 94 and the alignment line 96 are used when adjusting the polarization of the antennas 20.

At this point, the transceiver 10 should be in close enough alignment in all three required planes on order to establish communication with the satellite. Once communication with the satellite is established, the signal strength indicator may be used to assist the user in making fine adjustments in order to optimize the signal strength. Such fine adjustments may include rotating the adjustment member 62 for making minor changes in the elevational angle of the antenna support member 14, rotating the antenna housing 16 for making fine adjustments in the polarization angle of the antennas 20 and in slightly adjusting the orientation of the base unit housing 18 on the supporting surface to adjust the azimuth. Once the communication with the satellite has been optimized, no further adjustments to the transceiver 10 should be required during a communications session.

Once the communication session has been completed, the antenna housing 16 may be rotated back to its original position generally aligned with the antenna support member 14, the antenna support member 14 may be lowered to its original, transport position as shown in FIG. 2 and the adjustable feet 36 may be rotated to their retracted position to facilitate transport of the transceiver 10.

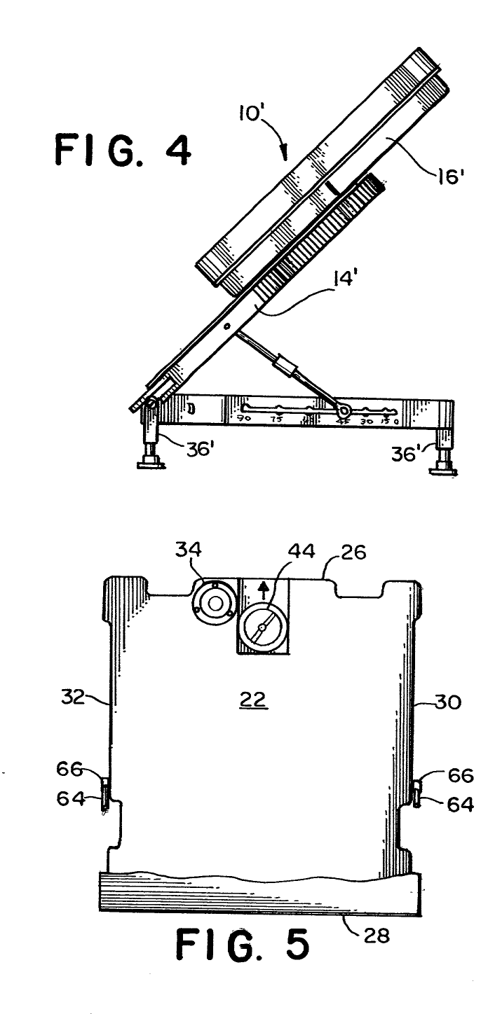

FIG. 4 shows an alternate embodiment of a transceiver 10′ in accordance with the present invention. The transceiver 10′ in substantially the same as the transceiver 10 as described above in connection with FIGS. 1-3 and 5-8. However, unlike the above-described transceiver 10, the transceiver 10′ of FIG. 4 includes an additional slot arrangement (not shown) that permits the antenna housing 16′ to effectively slide upwardly or downwardly with respect to the antenna support member 14′. In this manner, the antenna housing 16′ may be rotated with respect to the antenna support member 14′ without interference from a supporting surface in the event that the adjustable feet 36′ are not extended. Alternatively, the transceiver 10′ of FIG. 4 may be employed without any adjustable feet 36′. Operation of the transceiver 10′ is substantially the same as described above in connection with transceiver 10. However, if needed, the antenna housing 16′ may slide upwardly with respect to the antenna support member 14′ to facilitate rotation of the antenna housing 16′.

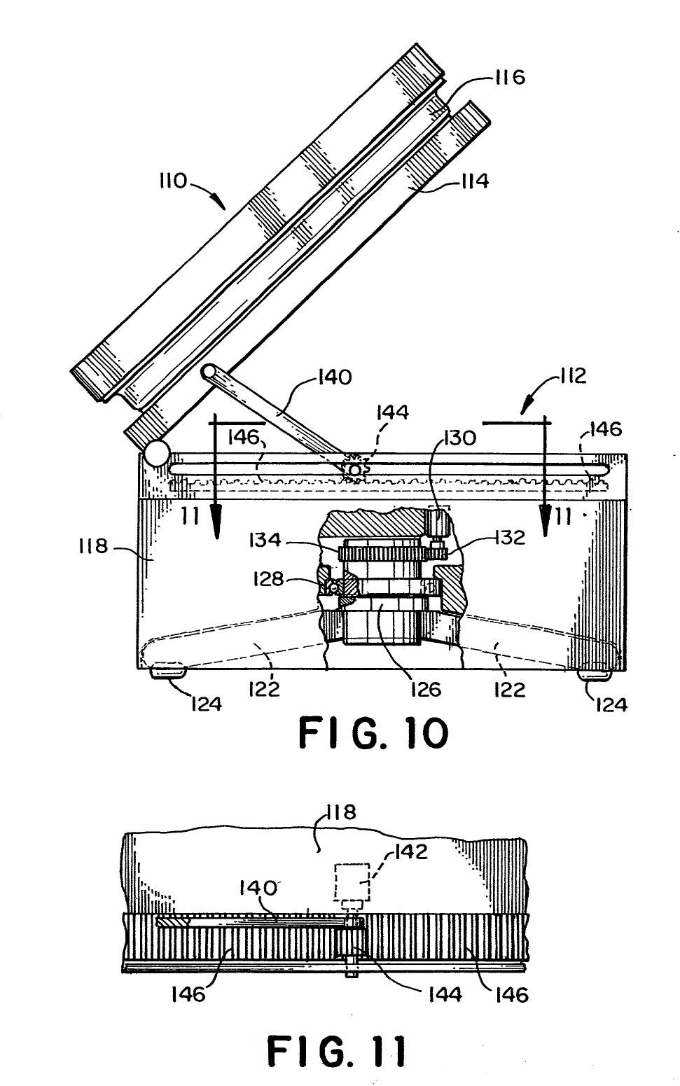

FIGS. 10-14 illustrate a second preferred embodiment of a transceiver 110 in accordance with the present invention. The transceiver 110 is similar to the transceiver 10 described above in connection with the first embodiment. Thus, the transceiver 110 includes three principle assemblies: a base unit 112, an antenna support member 114 and an antenna housing 116 all of which are substantially similar to the corresponding assemblies of the above-described first embodiment. Accordingly, in describing the transceiver 110 of the second preferred embodiment, only those structural and operational features which are different from the first embodiment will be described.

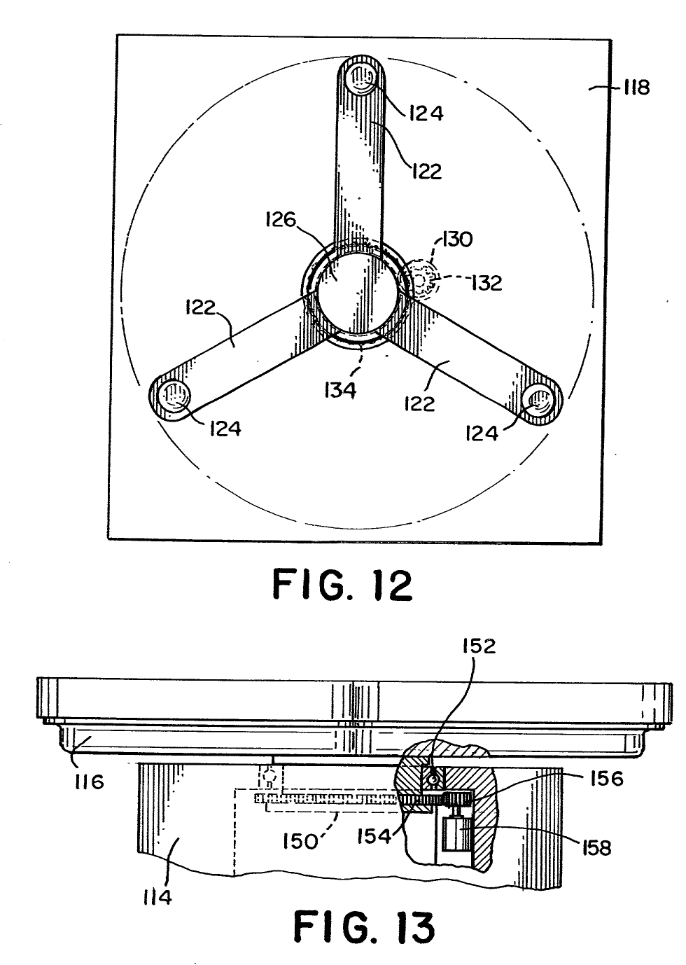

The principal difference between the transceiver 10 of the first embodiment and the transceiver 110 of the second embodiment is that the transceiver 110 of the second embodiment has the ability to achieve both coarse alignment and fine alignment of the antennas with the selected satellite in an automated manner. Referring now to FIGS. 10 and 12, the base unit 112 includes a base unit housing 118, which preferably is box-like and square just like the base unit housing 18 of the first preferred embodiment. However, the base unit housing 118 has a substantially greater height in order to accommodate automated azimuth orientation as described below.

The base unit housing 118 is supported on a support base comprised of a plurality of legs 122 in the illustrated embodiment three such legs arranged approximately 120° apart. The distal ends of each of the legs 122 include rubber feet 124 or other similar members to provide suitable non-slip gripping of an underlining supporting surface. The other ends of the legs 122 are secured to an upwardly extending generally cylindrical support member 126. The base unit housing 118, in turn, is rotatably supported by the cylindrical support member 126 utilizing a ball bearing assembly 128. A drive mechanism including a small electrical servo motor 130 secured the base unit housing 118 includes an output shaft, having a pinion gear 132. The teeth of the gear 132 engage the teeth of a corresponding gear 134 which extends around the circumference of the cylindrical support member 126. In this manner, actuation of the servo motor 130 causes the first gear 132 to rotate around the second gear 134 of the cylindrical support member 126 to thereby, effectively rotate the base unit housing 118 with respect to the support base. Rotation of the base unit housing 118 in this manner is employed for proper azimuth alignment of the transceiver antennas with the satellite in a manner which will hereinafter be described. It will be appreciated by those of ordinary skill in the art that while the present embodiment employs the above-described servo motor/gear arrangement for adjusting the position of the base unit housing 118, other suitable drive mechanisms or techniques could alternatively be employed for adjusting the alignment of the base unit housing 118. Preferably, the legs 122, cylindrical support member 126 and the gears 132, 134 are all formed of a generally rigid, high strength polymeric material. Alternatively, such support base components could be formed of another suitable material, such as an aluminum alloy, steel alloy, or the like. The servo motor 130 is of a type well known to those of ordinary skill in the art. Alternatively, a stepper motor, or other suitable motor may be employed. If desired, other support members, such as a self-lubricating plastic or nylon support member may be employed instead of the ball bearing assembly 128.

As with the above-described first preferred embodiment, the antenna support member 114 is rotatably attached on one end to the base unit housing 118 to permit the antenna support member 114 to pivot to a selected angle suitable for elevational orientation of the antennas with respect to the satellite. A support assembly facilitates pivotal movement. As shown in FIGS. 10 and 11 as part of the support assembly, a first end of a generally rigid support arm 140 is pivotable connected at a fixed location on the antenna support member 114. The other end of the support member 140 is connected a drive mechanism which includes a small electric servo motor 142. The output shaft of the servo motor 142 is connected to the support member 140 and includes a pinion gear 144 having teeth which engage suitably sized teeth of a rack member 146 within the base unit housing 118. Energizing the servo motor 142 causes the pinion gear 144 to rotate thereby moving the servo motor 142, pinion gear 144 and the distal end of the support member 140 linearly along the rack 146 in a direction which is determined by the direction of rotation of the output shaft of the servo motor 142. As can be appreciated by viewing FIGS. 10 and 11, movement of the distal end of the support member 140, along the rack 146 causes the antenna support member 114 to pivot upwardly or downwardly depending upon the direction of movement along the rack 146. In this manner, the elevational angle of the antennas can be adjusted with respect to the satellite. It will be appreciated by those of ordinary skill in the art that while the present embodiment employs a drive mechanism including a servo motor 142 in conjunction with a rack 146 and pinion gear 144 arrangement to move the distal end of a support member 140 for raising or lowering the antenna support member 114, other drive mechanisms or techniques may alternatively be employed. Preferably, the support member 140 and pinion gear 144 are formed of a high strength polymeric material but any other suitable generally rigid high strength material may alternatively be employed. In addition, while a servo motor 142 is employed in the present embodiment, any other suitable driving device, such as a stepper motor, could alternatively be employed.

In the present embodiment, the antenna housing 116 is rotatably supported by the antenna support member 114 in substantially the same manner as described above in connection with the first preferred embodiment. That is, the antenna housing 116 includes a downwardly extending generally cylindrical boss 150 which is journaled for rotation within a similarly sized opening in the antenna support member 114 by a ball bearing assembly 152. A gear 154 is secured to the outer surface of the boss 150. The teeth of the gear 154 are engaged with the teeth of a gear 156 secured to the output shaft of a servo motor 158 within the antenna support member 114. In this manner, operation of the servo motor 158 drives the gear 156 to rotate, which in turn causes the gear 154 and the boss 150 to correspondingly rotate to rotate the antenna housing 116 for aligning the polarization of the antennas with the polarization of the satellite antennas. It will be appreciated by those of ordinary skill in the art that while in the present embodiment, a driver mechanism including a servo motor 158, gears 154, 156 are disclosed, any other suitable drive mechanism or technique could be employed for rotating the antenna housing 116. Preferably, the boss 150 and gears 154 and 156 are made of a high strength polymeric material. However, it will be appreciated that other high strength materials, such as aluminum or steel alloys may alternatively be employed. It will also be appreciated by those of ordinary skill in the art that while a servo motor 158 is used in the present embodiment, a stepper motor or other suitable driving mechanism could alternatively be employed.

In the present embodiment, two electronic inclinometers (not shown) are employed for determining the elevation and polarization of the antennas. The use of inclinometers avoids necessity for the transceiver 110 to be set-up and leveled before beginning the alignment process. The transceiver 110 also includes a flux-gate compass (not shown) for determining the azimuth of the antennas. The transceiver 110 further preferably includes a global positioning system (GPS) receiver in order to precisely determine, in an automated manner, the location of the transceiver 110 on the earth's surface and the precise height of the transceiver 110 above sea level to assist in the automated alignment process. Alternatively, a user may manually enter location information, either in terms of a zip code, postal code, longitude and latitude, etc. and the transceiver 110 may obtain the necessary locational information utilizing a database lookup. Once the transceiver 110 is aware of its precise location and elevation, the transceiver 110 includes stored information to permit the transceiver 110 to determine the most appropriate satellite to use in establishing a communication link. The transceiver 110 then calculates the required information necessary for orientation of the transceiver 110 for optimal communication with the selected satellite using a stored database, simple trigonometric calculations or any other technique known to those of ordinary skill in the art.

Using the calculated or otherwise obtained information, the transceiver 110 activates servo motor 130 to orient the base unit housing 118 in the correct direction or along the correct azimuth for alignment with the selected satellite. Thereafter, the transceiver 110 activates servo motor 142 for adjusting the elevation of the antenna support member 114 to the correct elevation for communication with the selected satellite. Finally, the transceiver 110 activates servo motor 158 to rotate the antenna housing 116 to align the polarization of the antennas within the antenna housing 116 with the antennas of the selected satellite. Thereafter, communication with the selected satellite is established utilizing the transceiver 110. Once the initial communication with the satellite is established, the transceiver 110 actuates one or more of the servo motor 130, 142, 158 to more finely adjust the azimuth, elevational and antenna polarization, utilizing the signal strength indicator, to optimize the communication link.

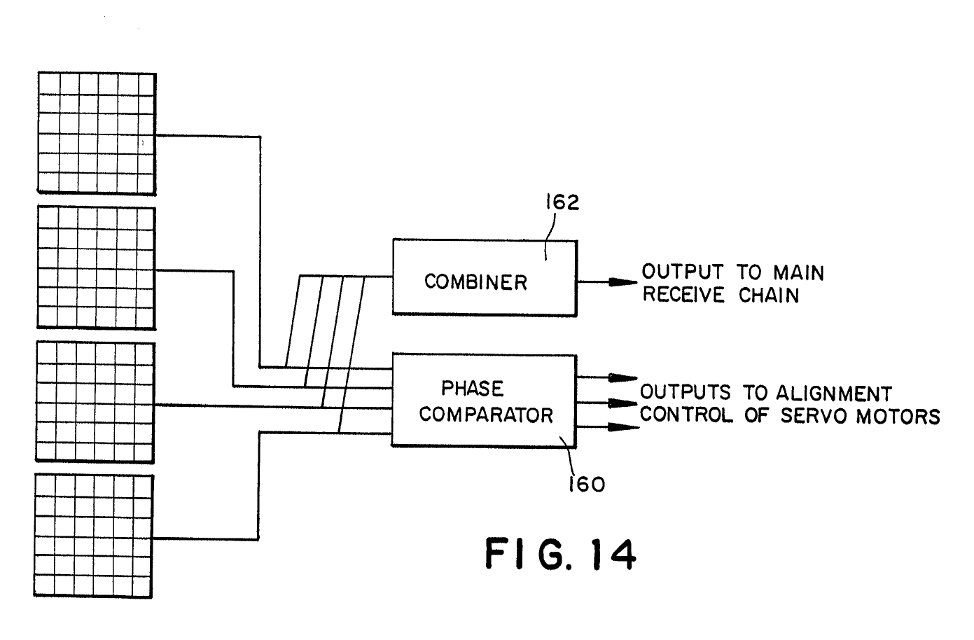

One example of a method of measuring the received signal strength of the transceiver is shown on FIG. 14. The RF output from each of the antenna quadrants is fed into a phase comparator circuit 160, which compares the relative signal characteristics such as signal strength and phase of the four received signals and generates adjustment signals for adjusting the azimuth, elevation and polarization to improve the alignment of the antennas within the transceiver 110 with the satellite antennas. The outputs from the phase comparator circuit are employed for driving the servo motors 130, 142 and 158. Simultaneously, the RF outputs from the four antenna quadrants are combined in a combiner circuit 162, which is passed to the remainder of the electrical and electronic components for normal down conversion to base band and subsequent processing to establish the transceiver output.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A portable, self-contained satellite transceiver for establishing a communications link between a connected appliance and a satellite, including polarized transmit and receive antennas, the transceiver comprising:
a base unit including a housing containing electronic components of the transceiver, the housing including a generally planar upper surface, a lower surface generally parallel with the upper surface and a direction indicator to facilitate orientation of the base unit along a selected azimuth for communication with the satellite;
a generally plate-like antenna support member having a generally planar lower surface and a generally planar upper surface generally parallel with the lower surface, one end of the antenna support member being pivotally connected to one end of the base unit housing so that the antenna support member is pivotable between a first position in which the lower surface of the antenna support member is facing and generally parallel with the upper surface of the base unit housing and a second position in which the lower surface of the antenna support member forms a selectable angle with respect to the upper surface of the base unit housing to establish elevational alignment with the satellite; and
an antenna housing containing polarized transmit and receive antennas suitable for use in communicating with the satellite, the antenna housing having a generally planar lower surface which is generally parallel with the upper surface of the antenna support member, the antenna support member rotatably supporting the antenna housing so that the antenna housing is rotatable to a selected angle for aligning the polarization of the antennas within the antenna housing with the polarization of the satellite antennas.

2. The satellite transceiver as recited in claim 1 wherein the direction indicator comprises a compass.

3. The satellite transceiver as recited in claim 2 wherein the compass is a fluxgate digital compass.

4. The satellite transceiver as recited in claim 1 wherein the base unit housing further includes a level measuring device for indicating whether the housing is level.

5. The satellite transceiver as recited in claim 4 wherein the level measuring device comprises a bubble spirit level.

6. The satellite transceiver as recited in claim 4 wherein the base unit housing further includes a plurality of adjustable feet extending downwardly from the lower surface, the feet being independently adjustable for leveling the base unit housing.

7. The satellite transceiver as recited in claim 6 wherein the adjustable feet are retractable from an extended position to a stowed position during transport of the satellite transceiver.

8. The satellite transceiver as recited in claim 1 wherein the base unit housing further includes, a signal strength detector for indicating the strength of signals received from the satellite.

9. The satellite transceiver as recited in claim 1 wherein the base unit is generally box-like and is formed of a polymeric material.

10. The satellite transceiver as recited in claim 1 wherein the antenna support member is connected to the base unit housing with a hinge connection utilizing at least one pin.

11. The satellite transceiver as recited in claim 1 wherein the base unit housing is rotatably supported on a support base for rotation to facilitate orientation of the base unit along the selected azimuth.

12. The satellite transceiver as recited in claim 11, further including a drive mechanism for rotating the base unit housing.

13. The satellite transceiver as recited in claim 1 further including a support assembly extending between the base unit housing and the antenna support member for retaining the antenna support member at the selected angle.

14. The satellite transceiver as recited in claim 13 wherein the support assembly includes an adjustment member for adjusting the antenna support member to the selected angle.

15. The satellite transceiver as recited in claim 14 further including a drive mechanism for adjusting the position of the support assembly to adjust the angle of the antenna support member.

16. The satellite transceiver as recited in claim 1 further including an indicator for displaying the elevation angle of the antenna support member with respect to the base unit housing.

17. The satellite transceiver as recited in claim 1 wherein the antenna support member is formed of a polymeric material.

18. The satellite transceiver as recited in claim 1 wherein the transmit and receive antennas are orthagonially organized.

19. The satellite transceiver as recited in claim 1 further including an indicator for displaying the angle of rotation of the antenna housing with respect to the antenna support member for indicating a polarization angle.

20. The satellite transceiver as recited in claim 1 wherein the antenna housing is rotatably supported by the antenna support member utilizing a rotatable joint for permitting rotation of the antenna housing in one degree increments and for holding the antenna housing at the selected angle.

21. The satellite transceiver as recited in claim 20 wherein the rotatable joint includes a detent mechanism for holding the antenna housing at the selected angle.

22. The satellite transceiver as recited in claim 1 wherein the antenna housing is formed of a metalized polymeric material.

23. The satellite transceiver as recited in claim 1, further, including a drive mechanism for rotating the antenna housing.

24. The satellite transceiver as recited in claim 1, wherein the antenna housing contains a plurality of antenna elements orthagonally arranged in four generally equally sized quadrants.

25. The satellite transceiver as recited in claim 1, wherein an output signal from the antennas in each quadrant is fed into a phase comparator circuit which compares the relative signal characteristics of each of the received signals and generates adjustment signals for fine adjustment of the azimuth, elevation and polarization of the transceiver antennas.

26. A portable, self-contained satellite transceiver for establishing a communications a link between a connected appliance and a satellite, including polarized transmit and receive antennas, the transceiver comprising:
a base unit including a housing, the housing including a direction indicator to facilitate orientation of the base unit along a selected azimuth for communication with the satellite;
a generally plate-like antenna support member, one end of the antenna support member being pivotally connected to one end of the base unit housing so that the antenna support member is pivotable between a first position in which the antenna support member is facing and generally parallel with the base unit housing and a second position in which the antenna support member forms a selectable angle with respect to the base unit housing to establish elevational alignment with the satellite; and
an antenna housing containing polarized transmit and receive antennas suitable for use in communicating with the satellite, the antenna support member rotatably supporting the antenna housing so that the antenna housing is rotatable to a selected angle for aligning the polarization of the antennas within the antenna housing with the polarization of the satellite antennas.
